(19) United States
(12) Patent Application Publication
(10) Pub. No.: US 2024/0101390 A1
(43) Pub. Date: Mar. 28, 2024

(54) AN ELEVATOR DRIVE UNIT, AN ELEVATOR SYSTEM, AND A METHOD FOR MANAGING A REGENERATIVE POWER OF AN ELEVATOR SYSTEM

(71) Applicant: KONE Corporation, Helsinki (FI)

(72) Inventors: Tuukka KAUPPINEN, Helsinki (FI); Mikko PAAKKINEN, Helsinki (FI); Risto JOKINEN, Helsinki (FI); Perttu KAIPIA, Helsinki (FI)

(73) Assignee: KONE Corporation, Helsinki (FI)

(21) Appl. No.: 18/533,396

(22) Filed: Dec. 8, 2023

Related U.S. Application Data
(63) Continuation of application No. PCT/EP2021/068476, filed on Jul. 5, 2021.

(51) Int. Cl. B66B 1/30; H02P 3/14

(52) U.S. Cl. CPC B66B 1/30; H02P 3/14

(57) ABSTRACT

The invention relates to an elevator drive unit for managing a regenerative power of an elevator system. The elevator drive unit comprises: first terminals for connecting the elevator drive unit to the mains; second terminals for connecting the elevator drive unit to an elevator hoisting motor; a frequency converter for enabling a bidirectional transfer of power between the mains and the elevator hoisting motor; and a control unit. The control unit is configured to: obtain an indication representing a detection of a special operational situation of the elevator system, introduce a non-zero power limit specific to the detected special operational situation of the elevator system, and control the frequency converter to limit supply of the regenerative power from the elevator hoisting motor to the mains to the power limit. The invention relates also to an elevator system and a method for managing a regenerative power of an elevator system.

### TECHNICAL FIELD

The invention concerns in general the technical field of elevators. Especially the invention concerns elevator drive units.

### BACKGROUND

A modern elevator system comprises an elevator drive system configured to drive an elevator car in an elevator shaft between a plurality of landings, according to service requests received e.g. from elevator passengers. The elevator drive system comprises an elevator hoisting motor, such as a permanent magnet motor, and an elevator drive unit for controlling the hoisting motor. The elevator drive unit comprises power switches, such as Insulated-gate bipolar transistors (IGBTs), metal-oxide-semiconductor field-effect transistors (MOSFETs), Gallium Nitride (GalN)-transistors, or Silicon Carbide (SiC)-transistors arranged e.g. as a frequency converter. The frequency converter may have AC input terminals connected to the mains electricity, and AC output terminals connected to windings of the elevator hoisting motor. The frequency converter may be operable to convert mains AC voltage (e.g. 50 Hz, 230V voltage) into a variable voltage, i.e. variable amplitude, variable frequency AC voltage of the elevator hoisting motor.

A modern elevator drive unit may operate selectively in a motoring mode or in a regenerating mode. In the motoring mode, the elevator drive unit will transfer electrical power from mains to the elevator hoisting motor. In the regenerating mode, the elevator drive unit will return regenerated power (e.g. braking power) from the elevator hoisting motor back to the mains.

In special operational situations, the supply of the regenerative power back to the AC mains may be reduced. One such operational situation is mains power outage, but it is to be understood that other situations may occur as well. Typically, the elevator drive systems are equipped with an additional brake chopper circuitry to handle the regenerative power in such special operational situation. The Brake chopper circuitry comprises a power resistor and a power transistor to control current through the resistor. By means of the brake chopper circuitry, any extra power is consumed into heat in the power resistor.

The brake chopper circuitry may be large, expensive and difficult to integrate into the elevator drive unit. It may also be a source of additional electromagnetic disturbance, such as common-mode disturbance of the building.

Thus, there is a need to develop further solutions to improve managing of regenerative power in elevator systems.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an elevator drive unit, an elevator system, and a method for managing a regenerative power of an elevator system. Another objective of the invention is that the elevator drive unit, the elevator system, and the method for managing a regenerative power of an elevator system enables an improved management of the regenerative power of the elevator system.

The objectives of the invention are reached by an elevator drive unit, an elevator system, and a method as defined by the respective independent claims.

According to a first aspect, an elevator drive unit for managing a regenerative power of an elevator system is provided, wherein the elevator drive unit comprises: first terminals for connecting the elevator drive unit to the mains; second terminals for connecting the elevator drive unit to an elevator hoisting motor; a frequency converter for enabling a bidirectional transfer of power between the mains and the elevator hoisting motor; and a control unit configured to: obtain an indication representing a detection of a special operational situation of the elevator system, introduce a non-zero power limit specific to the detected special operational situation of the elevator system, and control the frequency converter to limit supply of the regenerative power from the elevator hoisting motor to the mains to the power limit.

The control unit may be configured to control the frequency converter to control a motor current to increase power losses of the elevator hoisting motor.

The control unit may be configured to introduce harmonics into the motor current to increase the power losses of the elevator hoisting motor.

Alternatively or in addition, the control unit may be configured to control the frequency converter to control the elevator hoisting motor to increase power losses of the elevator hoisting motor.

The control unit may be configured control the frequency converter to control the elevator hoisting motor to operate in a field-weakening mode to increase the power losses of the elevator hoisting motor.

The power losses of the elevator hoisting motor may comprise core losses and/or resistive losses in the elevator hoisting motor.

Alternatively or in addition, the control unit may be configured to control the frequency converter to increase power losses of the frequency converter.

The special operational situation of the elevator system may comprise a situation requiring reduction of the regenerative power supplied from the elevator hoisting motor to the mains.

Alternatively or in addition, the special operational situation of the elevator system may comprise mains power outage situation, mains power shortage situation, a backup power supply situation, a braking situation of an elevator car of the elevator system, an overheating situation of an elevator component, and/or a smart grid situation.

The elevator drive unit may further comprise power switch devices arranged as the frequency converter, wherein the control unit may be connected to control poles of the power switch devices.

The frequency converter may comprise: a rectifier bridge formed by power switch devices, the rectifier bridge comprises an AC input connected to the first terminals and a DC output; and a motor bridge formed by power switch devices, the motor bridge comprises an AC output connected to the second terminals and a DC input connected to the DC output of the rectifier bridge via a DC link; wherein the control unit may be connected to control poles of the power switch devices of the rectifier bridge and the motor bridge, and wherein the control unit may be configured to: control the rectifier bridge to limit supply of the regenerative power from the DC link to the mains to the power limit by controlling the power switch devices of the rectifier bridge, and control the motor bridge to control a motor current to limit supply of the regenerative power from the elevator hoisting motor to the DC link by increasing power losses of the elevator hoisting motor.

According to a second aspect, an elevator system is provided, wherein the elevator system comprises: an elevator control unit, an elevator car configured to travel along an elevator shaft between a plurality of landings, an elevator hoisting motor for driving the elevator car, and an elevator drive unit described above, wherein the elevator control unit is communicatively connected to the elevator drive unit.

The elevator control unit may be configured to determine a special operational situation of the elevator system.

Alternatively or in addition, the elevator control unit may be configured to determine at least one special operational situation specific non-zero power limit.

According to a third aspect, a method for managing a regenerative power of an elevator system is provided, wherein the method comprises: determining, by an elevator control unit, at least one special operational situation specific non-zero power limit; detecting, by the elevator control unit, a special operational situation of the elevator system; and limiting, by an elevator drive unit, supply of the regenerative power from an elevator hoisting motor to the mains to the power limit specific to the detected special operational situation the elevator system.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of an elevator drive system.

FIG. 3 illustrates schematically an example of a method for managing a regenerative power of an elevator system.

FIG. 4A illustrates schematically an example of a frequency converter of an elevator drive unit.

FIG. 4B illustrates schematically another example of the frequency converter of the elevator drive unit.

FIG. 5 illustrates schematically an example of components of a control unit of an elevator drive unit.

FIG. 6 illustrates schematically an example of components of an elevator control unit.

### DESCRIPTION OF THE EXEMPLIFYING EMBODIMENTS

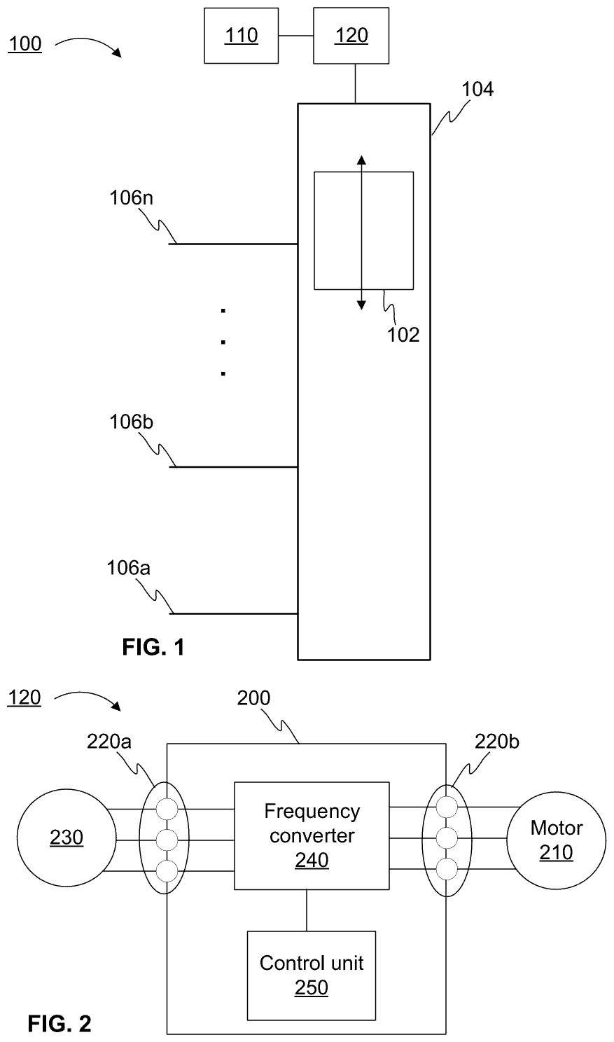

FIG. 1 illustrates schematically an example of an elevator system 100. The elevator system 100 comprises an elevator car 102 configured to travel along an elevator shaft 104 between a plurality of landings 106a-106n, an elevator control unit 110, and an elevator drive system 120. The elevator control unit 110 is configured to control the operation of the elevator system 100 at least in part. The elevator control unit 110 may reside e.g. in a machine room (for sake of the clarity not shown in FIG. 1) or in one of the landings 106a-106n of the elevator system 100. The elevator drive system 120 is configured to drive the elevator car 102 in the elevator shaft 104 between the plurality of landings 106a-106n, according to service requests received e.g. from elevator passengers. The elevator drive system 120 comprises an elevator drive unit 200 and an elevator hoisting motor 210 for driving the elevator car 102. The elevator drive unit 200 is configured to control the elevator hoisting motor 210. The elevator motor 210 may be e.g. a permanent magnet motor. The elevator control unit 110 may be communicatively connected, i.e. coupled, to the elevator drive unit 200. The communication between the elevator drive unit 200 and the elevator control unit 110 may be based on one or more known communication technologies, either wired or wireless. The elevator control unit 110 may command the elevator drive unit 200 to control the elevator hoisting motor 210 to move the elevator car 102 along the elevator shaft 104. The elevator system 100 may further comprise one or more other elevator related entities, e.g. safety circuit and devices, elevator door system, etc., which are not shown in FIG. 1 for sake of clarity.

FIG. 2 illustrates schematically an example of the elevator drive system 120 comprising the elevator drive unit 200 and the elevator hoisting motor 210. The elevator drive unit 200 comprises first terminals 220a, e.g. AC input terminals, for connecting the elevator drive unit 200 to mains 230; second terminals 220b, e.g. AC output terminals, for connecting the elevator drive unit 200 to the elevator hoisting motor 210, e.g. to windings of the elevator hoisting motor 210; a frequency converter 240; and a control unit 250. The frequency converter 240 enables a bidirectional transfer of power between the mains 230 and the elevator hoisting motor 210. The frequency converter 240 may be operable to convert mains AC voltage (e.g. 50 Hz, 230V voltage) into a variable amplitude, variable frequency AC voltage of the elevator hoisting motor 210. The drive unit 200 may comprise power switch devices 480a, 480b arranged as the frequency converter 240. In other words, the frequency converter 240 may be formed, i.e. constituted, by the power switch devices 480a, 480b. The control unit 250 of the elevator drive unit 200 may be connected to control poles of the power switch devices 480a, 480b. The power switch devices 480a, 480b may for example be Insulated-gate bipolar transistors (IGBTs), metal-oxide-semiconductor field-effect transistors (MOSFETs), Gallium Nitride (GalN)-transistors, or Silicon Carbide (SiC)-transistors. For sake of clarity, the power switch devices 480a, 480b are not shown in FIG. 2.

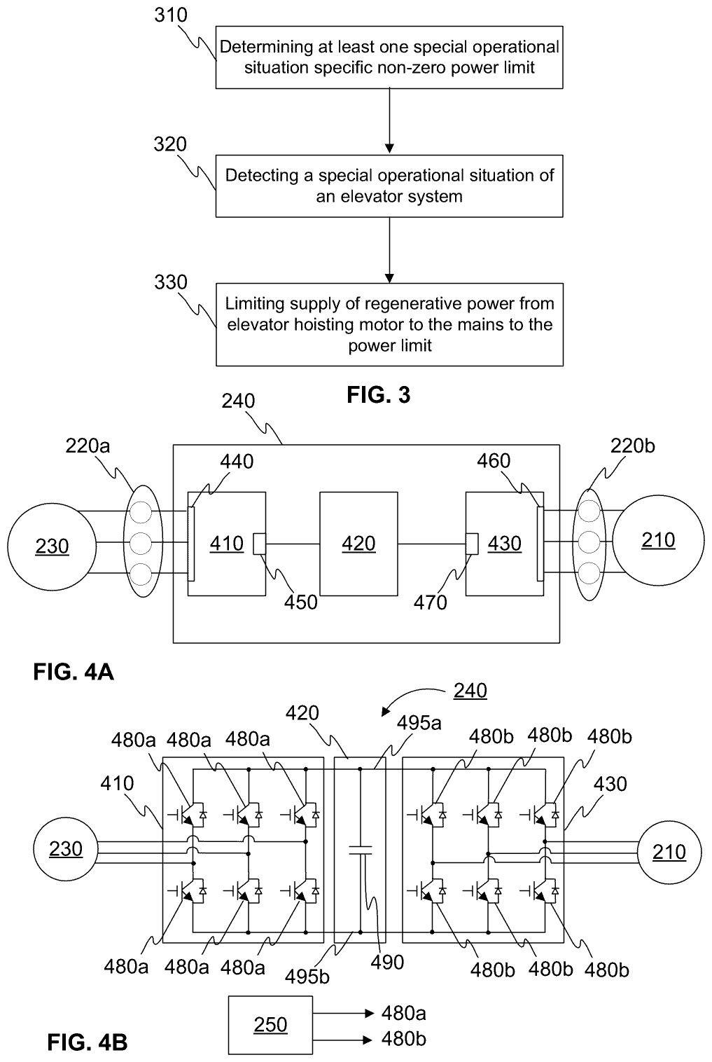

FIG. 3 schematically illustrates an example of a method for managing, i.e. handling, a regenerative power of the elevator system 100. FIG. 3 schematically illustrates the example method as a flow chart.

At a step 310, the elevator control unit 110 determines at least one special operational situation specific non-zero power limit. The elevator control unit 110 may provide to the control unit 250 of the elevator drive unit 200 the determined at least one special operational situation specific power limit. The expression “special operational situation specific” in the context of the power limit means throughout this application that the power limit may be specific for each special operational situation, i.e. determined according to the special operational situation. The expression “non-zero” in the context of the power limit means throughout this application that the power limit may be any positive power value, but not zero. The special operational situation of the elevator system 100 may comprise a situation requiring reduction of the regenerative power supplied from the elevator hoisting motor 210 to the mains 230. The special operational situation of the elevator system 100 may for example comprise, but is not limited to, mains power outage situation, mains power shortage situation, a backup power supply (e.g. generator supply) situation, a braking situation of the elevator car 102, an overheating situation of an elevator component (e.g. overheating of the elevator hoisting motor 210 or the elevator drive unit 200), and/or smart grid situation, i.e. a situation, wherein information about a specific operational situation is received from a power company. However, it is to be understood that other special operational situations may occur as well and at least one operational specific non-zero power limit may be determined also for said other special operational situations. According to an example, a first power limit may be determined, i.e. allocated, for the mains power outage situation, the mains power shortage situation, or the backup power supply situation, and a second power limit, e.g. higher than the first power limit, may be determined for a situation where the mains is operational, e.g. the braking situation of the elevator car 102. In the latter situation, the second power limit may be directed for example for limiting power peaks, e.g. power peaks occurring during regenerating, e.g. braking of the elevator car 102 moving at a full speed, for example, when starting a deceleration of the elevator car 102 from its nominal speed towards the destination floor.

At a step 320, the elevator control unit 110 detects a special operational situation of the elevator system 100. The detected special operational situation may belong to the operational situations for which the special operational situation specific non-zero power limit is determined at the step 310. In response to the detection of the special operational situation, the elevator control unit 110 provides to the control unit 250 of the elevator drive unit 200 an indication representing the detection of the special operational situation of the elevator system 100. The control unit 250 of the elevator drive unit 200 obtains, i.e. receives, the indication representing the detection of the special operational situation of the elevator system 100 from the elevator control unit 250. In response to obtaining the indication, the control unit 250 of the elevator drive unit 200 introduces the power limit specific to the detected special operational situation of the elevator system 100. In other words, the control unit 250 of the elevator drive unit 200 operates in a limited power mode in response to obtaining the indication representing the detection of the special operational situation of the elevator system 100 from the elevator control unit 250.

At a step 330, the control unit 250 of the elevator drive unit 200 controls the frequency converter 240 to limit supply of the regenerative power from the elevator hoisting motor 210 to the mains 230 to the power limit specific to the detected special operational situation of the elevator system 100. In other words, the control unit 250 of the elevator drive unit 200 controls the frequency converter 240 so that the supply of the regenerative power from the elevator hoisting motor 210 to the mains 230 is limited to the power limit specific to the detected special operational situation of the elevator system 100. Yet in other words, the regenerative power from the elevator hoisting motor 210 to the mains 230 is not allowed to exceed the power limit specific to the detected special operational situation of the elevator system 100 This enables that at least part of the regenerative power may be consumed into a heat in the elevator hoisting motor 210. Therefore, a separate brake chopper circuitry is not needed for handling the additional, i.e. extra, regenerative power. The control unit 250 of the elevator drive unit 200 may control, i.e. cause, the frequency converter 240 to limit the supply of the regenerative power from the elevator hoisting motor 210 to the mains 230 to the power limit specific to the detected special operational situation of the elevator system 100 by controlling the power switch devices 480a, 480b. The limiting of the supply of the regenerative power at the step 330 may be directed to an entire elevator run or to at least part of the elevator run, for example depending on the detected special operational situation.

According to an example, the controlling of the frequency converter 240 at the step 330 may comprise that the control unit 250 of the elevator drive unit 200 controls the frequency converter 240 to control a motor current to increase power losses of the elevator hoisting motor 210. The power losses may comprise core losses and/or resistive losses of the elevator hoisting motor 210, e.g. in the windings of the elevator hoisting motor 210. The control unit 250 of the elevator drive unit 200 may for example introduce harmonics into the motor current to increase the power losses of the elevator hoisting motor 210, e.g. the core losses.

According to another example, the controlling of the frequency converter 240 at the step 330 may alternatively or in addition comprise that the control unit 250 of the elevator drive unit 200 controls the frequency converter 240 to control the elevator hoisting motor 210 to increase the power losses of the elevator hoisting motor 210. The control unit 250 of the elevator drive unit 200 may for example control the frequency converter 240 to control the elevator hoisting motor 210 to operate in a field-weakening mode to increase the power losses of the elevator hoisting motor 210. In the field weakening mode a magnetization-axis current component is directed to the elevator hoisting motor 210 such that it weakens magnetization of the magnetization axis (i.e. d-axis), such as magnetization caused by permanent magnets of a permanent magnet motor. In the field weakening mode the elevator hoisting motor 210 may be operated above its rated speed but does not necessarily have to be operated above the rated speed. Typically, the field weakening mode may be used for operating above the rated speed, but even when used at the rated speed the field weakening mode may increase the motor current, which leads to increased resistive losses in the windings of the elevator hoisting motor 210 and therefore increased power losses in the elevator hoisting motor 210.

According to another example, the controlling of the frequency converter 240 at the step 330 may alternatively or in addition comprise that the control unit 250 controls the frequency converter 240 to increase power losses of the frequency converter 240. The power losses of the frequency converter 240 may comprise for example power losses of filter components of the frequency converter 240 (e.g. line filters, motor side DU/Dt filters) and/or power losses of fans of the frequency converter 240. The fans of the frequency converter 240 may be used for convective cooling of the power switch devices 480a, 480b of the frequency converter 240. The speed of the fans is controllable, and when the fans are used at full speed, they may consume even some kilowatts of extra power. For sake of clarity the fans are not shown in FIGS. 4A and 4B.

FIG. 4A illustrates schematically a simple example of the frequency converter 240 of the elevator drive unit 200. The example frequency converter 240 of FIG. 4A comprises a rectifier bridge 410 formed by power switch devices 480a and a motor bridge, i.e. an inverter bridge, 430 formed by power switch devices 480b. The rectifier bridge 410 comprises an AC input 440 connected to the first terminals 220a and a DC output 450. The motor bridge 430 comprises an AC output 460 connected to the second terminals 220b and a DC input 470 connected to the DC output 450 of the rectifier bridge 410 via a DC link 420. For sake of clarity the power switch devices 480a, 480b are not shown in FIG. 4A. FIG. 4B illustrates another example of the frequency converter 240 of the elevator drive unit 200. In the example of FIG. 4B non-limiting examples of the power switch devices 480a forming the rectifier bridge 410, the power switch devices 480b forming the motor bridge 430, and the DC link 420 are illustrated. Otherwise, the frequency converter 240 of the example of FIG. 4B is similar to the frequency converter 240 of the example of FIG. 4A. The DC link 420 may comprise for example, a capacitor 490 or a set of capacitors connected in parallel with a high voltage 495a and low voltage 495b busbars. The power switch devices 480a of the rectifier bridge 410 and the power switch devices 480b of the motor bridge 430 may for example be IGBTs, MOSFETs, GalN-transistors, or SiC-transistors as disclosed above. The control unit 250 of the elevator drive unit 200 is connected to control poles of the power switch devices 480a of the rectifier bridge 410 and to control poles of the power switch devices 480b of the motor bridge 430. For sake of clarity the first terminals 220a, the second terminals 220b, the AC input 440, the AC output 460, the DC output 450, and the DC input 470 are not shown in FIG. 4B.

When the elevator drive unit 200 is implemented by using the example frequency converter 240 of FIG. 4, the above discussed controlling step 330 may comprise that the control unit 250 of the elevator drive unit 200 controls, i.e. causes, the rectifier bridge 410 to limit supply of the regenerative power from the DC link 420 to the mains 230 to the power limit by controlling the power switch devices 480a of the rectifier bridge 410 and that the control unit 250 of the elevator drive unit 200 controls the motor bridge 430 to control the motor current to limit the supply of the regenerative power from the elevator hoisting motor 210 to the DC link 420 by increasing power losses of the elevator hoisting motor 210. This means that the limited mains power (Pₘₐᵢₙₛ) corresponds to the regenerated power (P_{reg}) subtracted with the amount of the power losses caused in the elevator hoisting motor 210 (Pₗₘ), internal power losses of the motor bridge (P_{lmb}) and internal power losses (P_{lrb}) of the rectifier bridge. In other words, the limited mains power may be defined by the following equation:

Pₘₐᵢₙₛ=P_{reg}−Pₗₘ−P_{lmb}−P_{lrb} (1)

The elevator drive system 120 may further comprise an additional brake chopper circuitry, which may be used for consuming the additional regenerative power not handled by the elevator drive system 100 as discussed above e.g. due to overheating problems of the elevator hoisting motor 210. The elevator drive system 120 may also comprise other loads or power drains, such as energy storages (e.g. batteries, supercapacitors etc.).

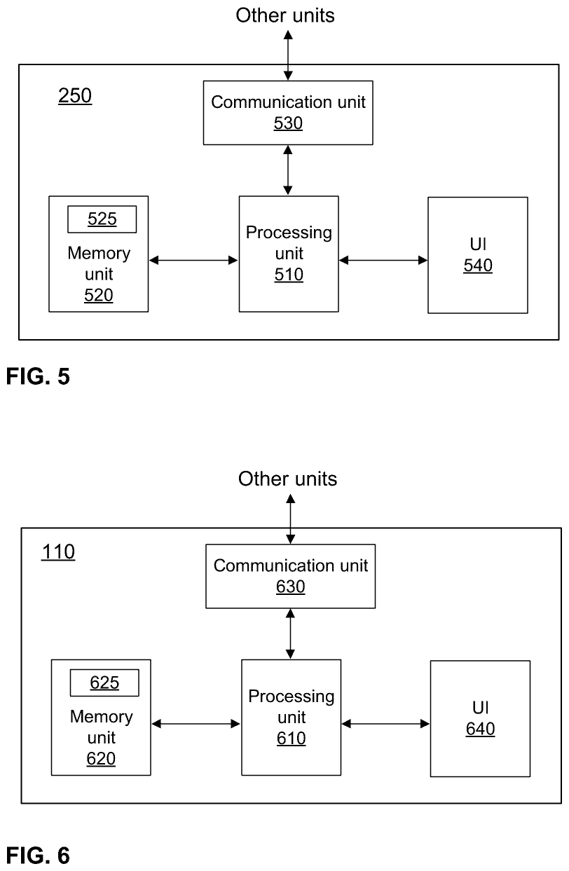

FIG. 5 illustrates schematically an example of components of the control unit 250 of the elevator drive unit 200. The control unit 250 may comprise a processing unit 510 comprising one or more processors, a memory unit 520 comprising one or more memories, a communication interface unit 530 comprising one or more communication devices, and possibly a user interface (UI) unit 540. The mentioned elements may be communicatively coupled to each other with e.g. an internal bus. The memory unit 520 may store and maintain portions of a computer program (code) 525 and any other data. The computer program 525 may comprise instructions which, when the computer program 525 is executed by the processing unit 510 of the control unit 250 of the elevator drive unit 200 may cause the processing unit 510, and thus the control unit 250 to carry out desired tasks, e.g. one or more of the method steps described above and/or the operations of the control unit 250 of the elevator drive unit 200 described above. The processing unit 510 may thus be arranged to access the memory unit 520 and retrieve and store any information therefrom and thereto. For sake of clarity, the processor herein refers to any unit suitable for processing information and control the operation of the control unit 250 of the elevator drive unit 200, among other tasks. The operations may also be implemented with a microcontroller solution with embedded software. Similarly, the memory unit 520 is not limited to a certain type of memory only, but any memory type suitable for storing the described pieces of information may be applied in the context of the present invention.

The communication interface unit 530 provides one or more communication interfaces for communication with any other unit, e.g. the frequency converter 240, the elevator control unit 110, and/or any other units. The user interface unit 540 may comprise one or more input/output (I/O) devices, such as buttons, keyboard, touch screen, microphone, loudspeaker, display and so on, for receiving user input and outputting information. The computer program 525 may be a computer program product that may be comprised in a tangible non-volatile (non-transitory) computer-readable medium bearing the computer program code 525 embodied therein for use with a computer, i.e. the control unit 250 of the elevator drive unit 200.

FIG. 6 illustrates schematically an example of components of the elevator control unit 110. The elevator control unit 110 may comprise a processing unit 610 comprising one or more processors, a memory unit 620 comprising one or more memories, a communication interface unit 630 comprising one or more communication devices, and possibly a user interface (UI) unit 640. The mentioned elements may be communicatively coupled to each other with e.g. an internal bus. The memory unit 620 may store and maintain portions of a computer program (code) 625 and any other data. The computer program 625 may comprise instructions which, when the computer program 625 is executed by the processing unit 610 of the elevator control unit 110 may cause the processing unit 610, and thus the elevator control unit 110 to carry out desired tasks, e.g. one or more of the method steps described above and/or the operations of the elevator control unit 110 described above. The processing unit 610 may thus be arranged to access the memory unit 620 and retrieve and store any information therefrom and thereto. For sake of clarity, the processor herein refers to any unit suitable for processing information and control the operation of the elevator control unit 110, among other tasks. The operations may also be implemented with a microcontroller solution with embedded software. Similarly, the memory unit 620 is not limited to a certain type of memory only, but any memory type suitable for storing the described pieces of information may be applied in the context of this application. The communication interface unit 630 provides one or more communication interfaces for communication with any other unit, e.g. the elevator drive unit 200, the control unit 250 of the elevator drive unit 200, and/or any other units. The user interface unit 640 may comprise one or more input/output (I/O) devices, such as buttons, keyboard, touch screen, microphone, loudspeaker, display and so on, for receiving user input and outputting information. The computer program 625 may be a computer program product that may be comprised in a tangible non-volatile (non-transitory) computer-readable medium bearing the computer program code 625 embodied therein for use with a computer, i.e. the elevator control unit 110.

The specific examples provided in the description given above should not be construed as limiting the applicability and/or the interpretation of the appended claims. Lists and groups of examples provided in the description given above are not exhaustive unless otherwise explicitly stated.

1. An elevator drive unit for managing a regenerative power of an elevator system, the elevator drive unit comprises:
first terminals for connecting the elevator drive unit to the mains;
second terminals for connecting the elevator drive unit to an elevator hoisting motor;
a frequency converter for enabling a bidirectional transfer of power between the mains and the elevator hoisting motor; and
a control unit configured to:
obtain an indication representing a detection of a special operational situation of the elevator system,
introduce a non-zero power limit specific to the detected special operational situation of the elevator system, and
control the frequency converter to limit supply of the regenerative power from the elevator hoisting motor to the mains to the power limit.

2. The elevator drive unit according to claim 1, wherein the control unit is configured to control the frequency converter to control a motor current to increase power losses of the elevator hoisting motor.

3. The elevator drive unit according to claim 2, wherein the control unit is configured to introduce harmonics into the motor current to increase the power losses of the elevator hoisting motor.

4. The elevator drive unit according to claim 1, wherein the control unit is configured to control the frequency converter to control the elevator hoisting motor to increase power losses of the elevator hoisting motor.

5. The elevator drive unit according to claim 4, wherein the control unit is configured control the frequency converter to control the elevator hoisting motor to operate in a field-weakening mode to increase the power losses of the elevator hoisting motor.

6. The elevator drive unit according to claim 2, wherein the power losses of the elevator hoisting motor comprise core losses and/or resistive losses in the elevator hoisting motor.

7. The elevator drive unit according to claim 1, wherein the control unit is configured to control the frequency converter to increase power losses of the frequency converter.

8. The elevator drive unit according to claim 1, wherein the special operational situation of the elevator system comprises a situation requiring reduction of the regenerative power supplied from the elevator hoisting motor to the mains.

9. The elevator drive unit according to claim 1, wherein the special operational situation of the elevator system comprises mains power outage situation, mains power shortage situation, a backup power supply situation, a braking situation of an elevator car of the elevator system, an overheating situation of an elevator component, and/or a smart grid situation.

10. The elevator drive unit according to claim 1, comprising power switch devices arranged as the frequency converter, wherein the control unit is connected to control poles of the power switch devices.

11. The elevator drive unit according to claim 1, wherein the frequency converter comprises:
a rectifier bridge formed by power switch devices, the rectifier bridge comprises an AC input connected to the first terminals and a DC output; and
a motor bridge formed by power switch devices, the motor bridge comprises an AC output connected to the second terminals and a DC input connected to the DC output of the rectifier bridge via a DC link;
wherein the control unit is connected to control poles of the power switch devices of the rectifier bridge and the motor bridge, and
wherein the control unit is configured to:
control the rectifier bridge to limit supply of the regenerative power from the DC link to the mains to the power limit by controlling the power switch devices of the rectifier bridge, and
control the motor bridge to control a motor current to limit supply of the regenerative power from the elevator hoisting motor to the DC link by increasing power losses of the elevator hoisting motor.

12. An elevator system comprising:
an elevator control unit,
an elevator car configured to travel along an elevator shaft between a plurality of landings,
an elevator hoisting motor for driving the elevator car, and
an elevator drive unit according to claim 1,
wherein the elevator control unit is communicatively connected to the elevator drive unit.

13. The elevator system according to claim 12, wherein the elevator control unit is configured to determine a special operational situation of the elevator system.

14. The elevator system according to claim 12, wherein the elevator control unit is configured to determine at least one special operational situation specific non-zero power limit.

15. A method for managing a regenerative power of an elevator system, the method comprising:
determining, by an elevator control unit, at least one special operational situation specific non-zero power limit;
detecting, by the elevator control unit, a special operational situation of the elevator system; and
limiting, by an elevator drive unit, supply of the regenerative power from an elevator hoisting motor to the mains to the power limit specific to the detected special operational situation the elevator system.

16. The elevator drive unit according to claim 2, wherein the control unit is configured to control the frequency converter to control the elevator hoisting motor to increase power losses of the elevator hoisting motor.

17. The elevator drive unit according to claim 3, wherein the control unit is configured to control the frequency converter to control the elevator hoisting motor to increase power losses of the elevator hoisting motor.

18. The elevator drive unit according to claim 3, wherein the power losses of the elevator hoisting motor comprise core losses and/or resistive losses in the elevator hoisting motor.

19. The elevator drive unit according to claim 4, wherein the power losses of the elevator hoisting motor comprise core losses and/or resistive losses in the elevator hoisting motor.

20. The elevator drive unit according to claim 5, wherein the power losses of the elevator hoisting motor comprise core losses and/or resistive losses in the elevator hoisting motor.
